(19) United States
(12) Patent Application Publication
(10) Pub. No.: US 2004/0200090 A1
(43) Pub. Date: Oct. 14, 2004

(54) Plastic dryer

(75) Inventors: Chih-Wei Tu, Tainan City (TW); Chih-Chien Tsao, Tainan City (TW); Yang-Kuei Liu, Tainan City (TW)

Correspondence Address: Chih-Wei Tu, P.O. Box 90, Tainan City, 704, TW

(73) Assignee: JIA HORNG TECHNOLOGY CORP.

(21) Appl. No.: 10/412,309

(22) Filed: Apr. 14, 2003

(51) Int. Cl. F26B 3/34

(52) U.S. Cl. 34/265; 34/259

(57) ABSTRACT

A plastic dryer has a drying tank provided with a magnetic control tube in the interior. The magnetic control tube is connected with a connecting tube, which has one end installed with an air filter having a wind inlet and the other end connected with a wind duct, which is connected with a windmill. Thus, microwave heating of the magnetic control tube is able to vaporize the water molecule of the plastic in the drying tank and dry it up with quickness, able to economize time and electricity and having excellent effect in drying plastic. The dried plastic is used for injecting molding by an injection-molding machine.

### BACKGROUND OF THE INVENTION

1. Field of the Invention

This invention relates to a plastic dryer, particularly to one having its drying tank provided inside with a magnetic control tube which is able to produce microwave heating to vaporize the water molecule of the plastic in the drying tank and dry it up with quickness, economizing time and electricity and having excellent effect in drying plastic. The dried plastic can be employed for injecting molding by an injection-molding machine.

2. Description of the Prior Art

A conventional plastic dryer, as shown in FIGS. 1 and 2, is provided with a drying tank 10 having a blower 11 fixed on the outer side. The blower 11 is provided at the lower side with a ramifying tube 12 having its lower end connected with a heating pipe 13. An intake tube 14 is positioned under the heating tube 13 and connected with the lower side of the drying tank 10. A conveying tube 15 is connected with the sidewall of the ramifying tube 12 and provided at the outer end with a pressure reducer 16 positioned on the drying tank 10. An electricity control box 17 is installed at one side of the heating tube 13. Thus, external air is pumped into the ramifying tube 12 by the blower 11, and part of the air gets into the lower portion of the drying tank 10 through the intake tube 14 after heated by the heating tube 13 and the other part of the air passes through the conveying tube 15 and the pressure reducer 16 and gets into the drying tank 10 from its topside. Under the circumstances, cold and hot air gather together in the drying tank 10 and produce positive and negative pressure and then the hot air is stored in the drying tank 10 for drying the lower-positioned plastic in the drying tank 10.

The conventional plastic dryer has plastic dried by electric heat which produces hot wind to bake and dry the surface and then the interior of the plastic, but it fails to dry up substantially the interior of the plastic in this way and it also needs to take a very long time to dry up the plastic by hot wind, not only wasting much electricity and time and increasing producing cost, but also causing plastic dust floating about in a factory premises.

### SUMMARY OF THE INVENTION

The objective of the invention is to offer a plastic dryer able to completely dry up plastic with quickness, economizing time and electricity in drying plastic.

The feature of the invention is a magnetic control tube provided in the interior of a drying tank and able to produce microwave heating to vaporize the water molecule of the plastic in the drying tank and dry it up with quickness, economizing much time and electricity and having excellent effect. The dried plastic can be employed for injecting molding by an injection-molding machine.

### BRIEF DESCRIPTION OF DRAWINGS

This invention will be better understood by referring to the accompanying drawings, wherein:

FIG. 1 is a perspective view of a conventional plastic dryer;

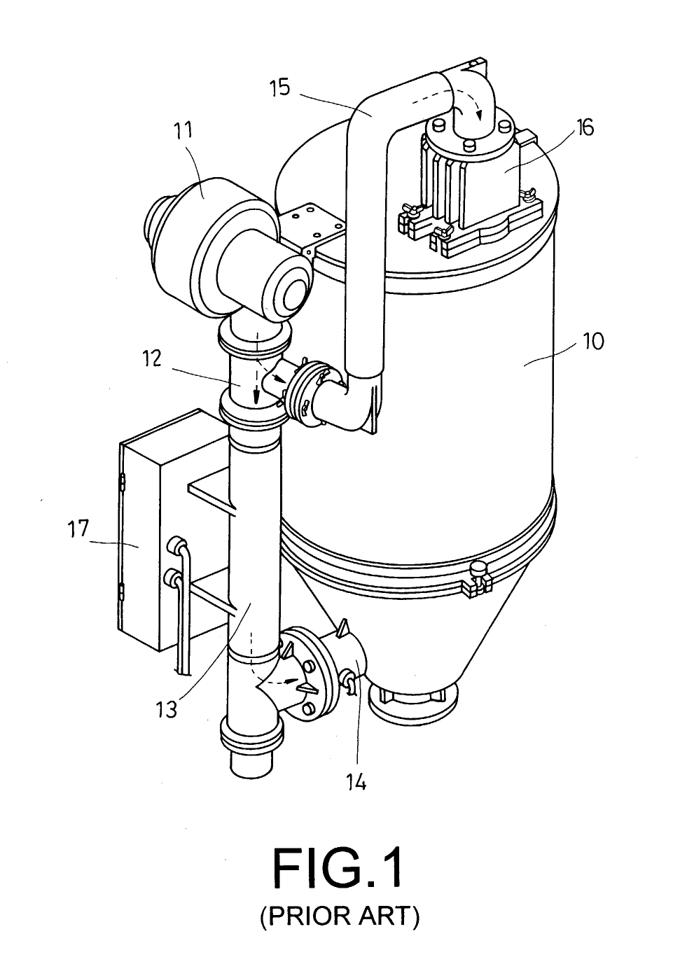

FIG. 2 is a cross-sectional view of the conventional plastic dryer in a using condition;

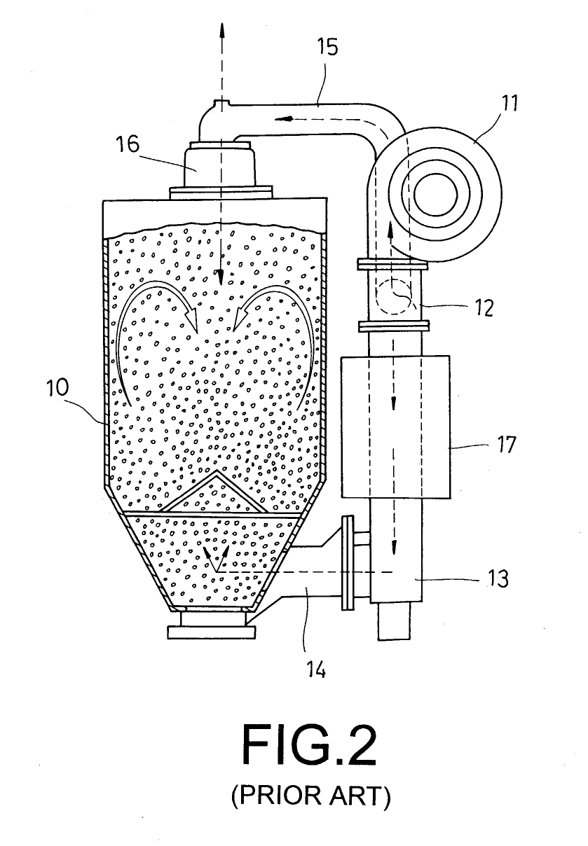

FIG. 3 is a front cross-sectional view of a plastic dryer in the present invention; and,

FIG. 4 is a cross-sectional view of the plastic dryer in a using condition in the present invention.

### DETAILED DESCRIPTION OF THE PREFERRED EMBODIMENT

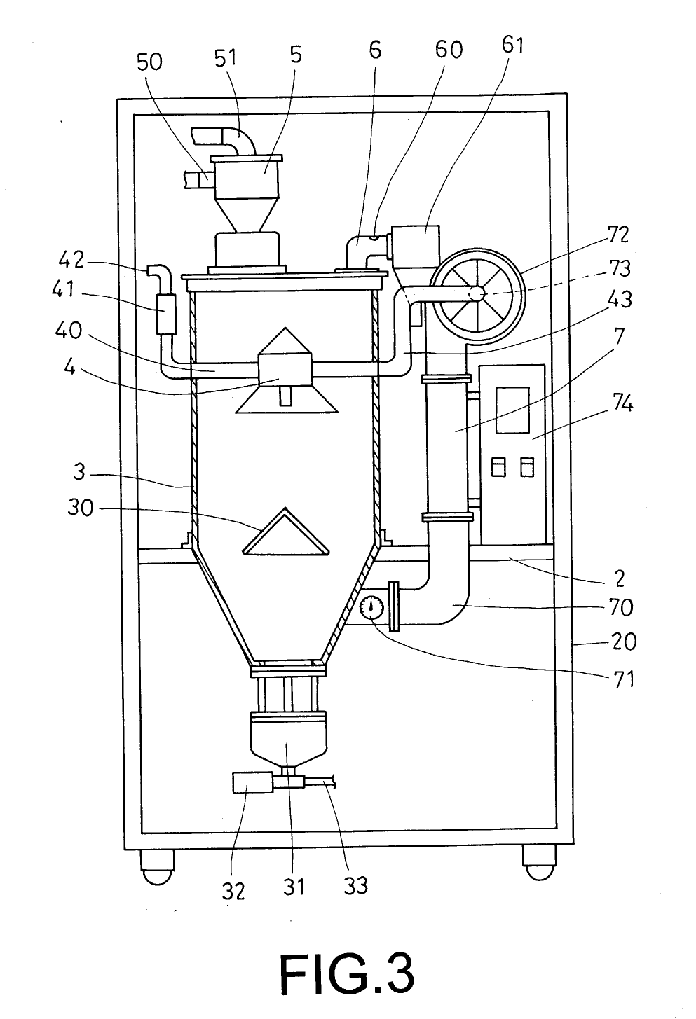

A preferred embodiment of a plastic dryer in the present invention, as shown in FIG. 3, includes a machine frame 2, a drying tank 3, a magnetic control tube 4, a material intake container 5, an exhaust tube 6 and an electric heating tube 7 as main components combined together.

The machine frame 2 has its outer side covered with a housing 20.

The drying tank 3 positioned in the machine frame 2 is provided with a material-balancing plate 30 near the lower end and a material-storing container 31 at the bottom. An air filter 32 and a material-guiding tube 33 are located under the material-storing container 31.

The magnetic control pipe 4 connected with a connecting tube 40 is positioned in the drying tank 3. The connecting tube 40 has one end provided with an air filter 41 having a wind inlet 42 and the other end provided with a wind duct 43.

The material intake container 5 is provided on the topside of the drying tank 3, having a material intake tube 50 and a wind duct 51.

The exhaust tube 6 is disposed on the drying tank 3, having its wall bored with an exhaust hole 60 and its outer end connected with a dust keeper 61.

The electric heating tube 7 is located by one side of the drying tank 3, having a connecting tube 70 disposed laterally at the bottom and connected with the lower portion of the drying tank 3 and also provided thereon with a thermometer 71. Besides, a windmill 72 is installed at the upper end of the electric heating tube 7, having a wind inlet 73 connected with the wind duct 43 of the magnetic control tube 4, and a control box 74 is provided beside the electric heating tube 7.

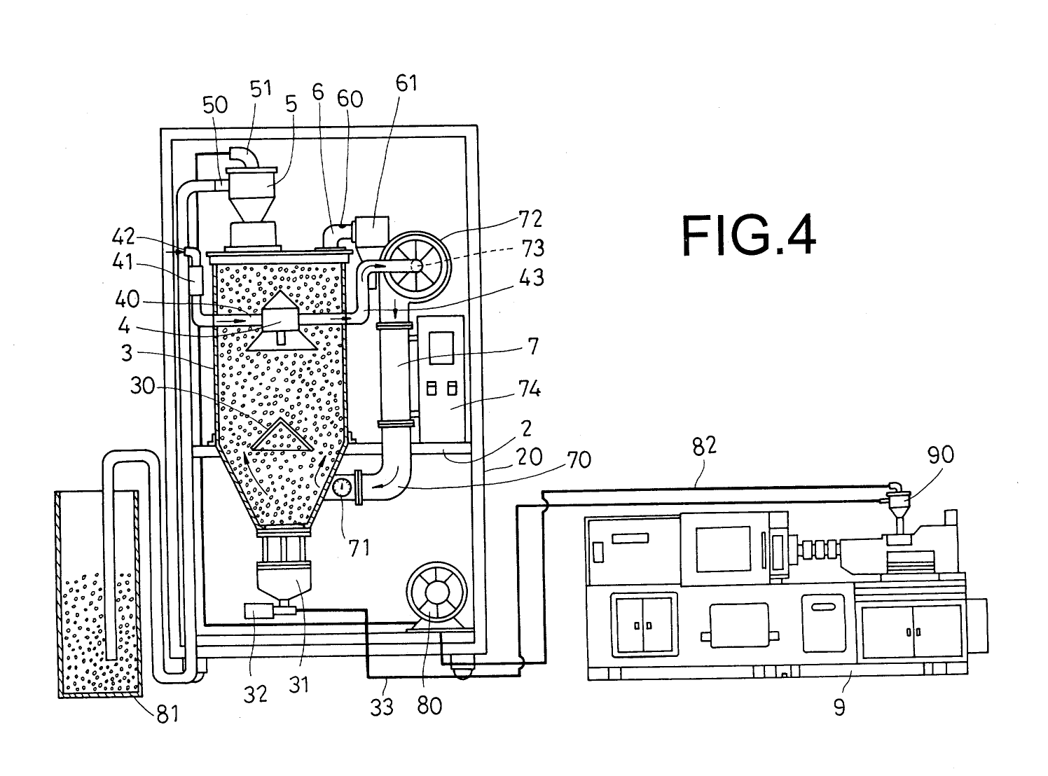

In using, as shown in FIG. 4, firstly, another windmill 80 is additionally installed inside the machine frame 2 and the wind duct 51 of the material intake container 5 has one end connected with the windmill 80. Then, the material intake tube 50 of the material intake container 5 is connected with the interior of a plastic container 81 and the windmill 80 has an additional wind duct 82 connected with the material container 90 of an injection-molding machine 9. Further, the material-guiding tube 33 of the material-storing container 31 has one end connected with the material container 90 of the injection-molding machine 9.

Next, moist plastic is placed in the plastic container 81 and the windmill 80 is started to have the plastic in the plastic container 81 sucked and conveyed into the material intake container 5 and then dropping into the drying tank 3. Simultaneously, start an electric heat switch and the windmill 72 respectively to let the electric heating tube 7 begin to produce heat to a set temperature and have external cold air sucked into the wind duct 43 through the wind inlet 42 of the air filter 41 and through the connecting tube 40 of the magnetic control tube 4. Subsequently, the cold air in the wind duct 43 is sucked by the windmill 72 and conveyed into the electric heating tube 7 to be heated therein. Then, the hot air in the electric heating tube 7 is exhausted into the drying tank 3 through the connecting tube 70 to blow upward the plastic in the drying tank 3 and roll it over circularly, and when the plastic is blown to reach a higher location than the magnetic control tube 4, the magnetic control tube 4 will start to generate microwave heat to vaporize the water molecule of the plastic and dry it up with quickness, able to save time and having excellent effect in drying plastic.

As can be noted from the above description, this invention has the following advantages:

1. The way of drying plastic by microwave heating of the magnetic control tube 4 has better effect and is much more economical in time and electricity than the conventional way of drying plastic by hot wind.

2. The vapor produced by microwave heating can be removed out through the exhaust hole 60 of the exhaust tube 6 on the topside of the drying tank 3, able to keep dry the interior of the drying tank 3.

3. The dust produced during drying the plastic can be collected by the dust keeper 61, able to keep clean the air in a factory premises.

4. External cold air sucked into the connecting tube 40 through the wind inlet 42 by the windmill 72 is able to lower the temperature of the magnetic control tube 4, able to reduce a damage rate and prolong the service life of the magnetic control tube 4.

5. Air passing through the connecting tube 40 of the magnetic control tube 4 can be guided to the windmill 72 through the wind duct 43 and, after heated by the electric heating tube 7, conveyed unto the drying tank 3 for use, enabling resources to be utilized repeatedly.

6. The electromagnetic wave generated by heating of the magnetic control tube 4 is obstructed by the drying tank 3 and the outer housing 20 of the machine frame 2, ensuring safety in use.

7. After dried, the plastic will drop into the material-storing container 31 and be stored therein. Thus, when the plastic in the material container 90 of an injection molding machine 9 drops to a lower location, start the windmill 80 to have the dried plastic stored in the material-storing container 31 conveyed into the material container 90 of the injection molding machine 9 for use through the material-guiding tube 33, easy in handling and convenient in use.

While the preferred embodiment of the invention has been described above, it will be recognized and understood that various modifications may be made therein and the appended claims are intended to cover all such modifications that may fall within the spirit and scope of the invention.

What is claimed is:

1. A plastic dryer comprising a machine frame, said machine frame having its outer side covered with a housing, said machine frame provided with a drying tank in the interior, said drying tank provided with a material-storing container at the lower end, an air filter and a material-guiding tube respectively positioned under said material-storing container, a material intake container disposed on the topside of said drying tank, said material intake container provided with a material intake tube and a wind duct, said drying tank provided inside with a material-balancing plate near a lower end, an electric heating tube disposed by the outer side of said drying tank, said electric heating tube provided at the lower end with a lateral connecting tube connected with the bottom portion of said drying tank, said connecting tube installed thereon with an thermometer, said electric heating tube having its upper end connected with a windmill, a control box positioned by one side of said electric heating tube; and,
characterized by a magnetic control tube provided in the interior of said drying tank, said magnetic control tube able to produce microwave heating to vaporize the water molecule of the plastic in said drying tank and dry it up fast, economizing time and electricity and having excellent effect in drying plastic, said dried plastic employed for injecting molding by an injection molding machine.

2. The plastic dryer as claimed in claim 1, wherein an exhaust tube having an exhaust hole is disposed on the topside of said drying tank, and said exhaust tube has its outer end connected with a dust keeper.

3. The plastic dryer as claimed in claim 1, wherein said material-guiding tube of said material-storing container has one end connected to said material container of said injection molding machine, used in projecting molding.

4. The plastic dryer as claimed in claim 1, wherein said magnetic control tube is connected with a connecting tube and positioned in the interior of said drying tank, and said connecting tube has one end installed with an air filter having a wind inlet and the other end provided with a wind duct connected with a windmill.
